(19) United States
(12) Patent Application Publication
(10) Pub. No.: US 2018/0107596 A1
(43) Pub. Date: Apr. 19, 2018

(54) BATTERY-BASED DATA PERSISTENCE MANAGEMENT IN COMPUTING SYSTEMS

(71) Applicant: Microsoft Technology Licensing, LLC, Redmond, WA (US)

(72) Inventors: Bryan Kelly, Carnation, WA (US); Bikash Sharma, Bellevue, WA (US); Anirudh Badam, Issaquah, WA (US); Sriram Govindan, Redmond, WA (US); Rajat Kateja, Pittsburgh, PA (US)

(21) Appl. No.: 15/406,933

(22) Filed: Jan. 16, 2017

Related U.S. Application Data
(60) Provisional application No. 62/407,858, filed on Oct. 13, 2016.

(51) Int. Cl. G06F 12/0804; G06F 1/26; G06F 1/30; G06F 9/30; G06F 11/07

(52) U.S. Cl. CPC G06F 12/0804; G06F 1/263; G06F 1/30; G06F 9/3004; G06F 2212/205; G06F 11/0751; G06F 11/0793; G06F 2212/1032; G06F 11/073

(57) ABSTRACT

Embodiments of battery-based data persistence management in computing devices are disclosed therein. In one embodiment, a method includes receiving a storage request to persistently store data in the computing device. In response to receiving the storage request, the method includes allocating a number of memory blocks of the main memory to store the data associated with the storage request and incrementing an accumulated number of memory blocks in the main memory that contain data stored in response to received storage requests. The method further includes maintaining the accumulated number of memory blocks in the main memory below a threshold corresponding to an energy capacity of the auxiliary power source and copying all of the stored data in the memory blocks of the main memory to the persistent storage using power from only the auxiliary power source when the main power supply suffers an unexpected power failure.

### CROSS-REFERENCE TO RELATED APPLICATION(S)

This application is a non-provisional application of and claims priority to U.S. Provisional Application No. 62/407,858, filed on Oct. 13, 2016.

### BACKGROUND

Servers in cloud computing datacenters can utilize non-volatile dual in-line memory modules (“NVDIMMs”) or other types of hybrid memory devices to achieve high application performance, data integrity, and rapid system recovery. Certain types of NVDIMMs (e.g., NVDIMM-Ns) can include a dynamic random access memory (“DRAM”) module operatively coupled to a flash memory module. The DRAM module allows fast memory access while the flash memory module can persistently retain data upon unexpected power losses, system crashes, or normal system shutdowns.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Though NVDIMM-Ns can provide fast memory access and persistently retain data upon unexpected power loses, NVDIMM-Ns are typically a lot more expensive than regular DRAM modules. As such, a computing device can be implemented with software NVDIMMs (“NVDIMM-SWs”) to emulate functions of the NVDIMM-Ns with a main memory and persistent storage of the computing device. For example, a portion of the main memory and the persistent storage can be designated as a volatile memory and a non-volatile memory of an NVDIMM-SW. During a power failure or normal shutdown, by executing routines with a main processor or other suitable controller, the computing device can copy or “flush” data residing in the designated portion of the main memory to the persistent storage via a peripheral component interconnect express (“PCIE”) bus on a motherboard by utilizing a battery or other suitable backup power sources.

One challenge of the foregoing arrangement is to ensure complete data flushing by utilizing a battery or other suitable backup power sources with limited power capacities. For example, a battery can be exhausted after providing power for a certain period of time. As such, the limited power capacities of the battery can limit an amount of data that can be flushed from the designated portion of the main memory to the persistent storage of NVDIMM-SWs. Thus, some data residing in the designated portion of the main memory may be lost if the battery is exhausted before complete data flushing is achieved. Such loss of data can negatively impact user experience and system performance.

Several embodiments of the disclosed technology can address at least certain aspects of the foregoing challenge by tracking an amount of data (referred to as “dirty data” herein) in the designated portion of the main memory (e.g., DRAM modules) of NVDIMM-SWs to be flushed to the persistent storage when powered by a battery or other suitable types of backup power sources. In embodiments, the dirty data can include data that has been recently modified by, for example, an application executing on a computing device incorporating the NVDIMM-SW. In embodiments, the dirty data can include system modified data or other suitable types of data to be persisted. In embodiments, the dirty data in the designated portion of the main memory can also be compressed, de-duplicated, or otherwise processed to reduce the amount of dirty data to be persisted.

In accordance with aspects of the disclosed technology, when the amount of dirty data in the designated portion of the main memory exceeds (or is about to exceed) a threshold set corresponding to an available capacity of the battery, a processor or other suitable components of the computing device can trigger flushing of at least a portion of the dirty data in the designated portion of the main memory to the persistent storage using a main power source (e.g., a power grid) not designated for providing power to flush dirty data in emergent situations. As such, the amount of the dirty data in the designated portion of the main memory can be maintained at or below the threshold to ensure complete flushing of the remaining dirty data during, for example, an unexpected failure or outage of the main power source. Thus, by tracking and flushing as needed the dirty data in the designated portion of the main memory, risks of unexpected data loss can be reduced and even avoided.

### BRIEF DESCRIPTION OF THE DRAWINGS

FIG. 1 is a schematic block diagram illustrating a computing system having computing units configured in accordance with embodiments of the present technology.

FIGS. 2A-2D are schematic block diagrams of a computing unit suitable for the computing system of FIG. 1 at various operational stages in accordance with embodiments of the present technology.

FIG. 3 is a block diagram showing software modules suitable for the main processor of FIGS. 2A-2D in accordance with embodiments of the present technology.

FIGS. 4 and 5 are flow diagrams illustrating various aspects of processes for ensuring data integrity during backup operations in accordance with embodiments of the present technology.

FIG. 6 is an example data structure for a page table in accordance with embodiments of the present technology.

FIG. 7 is a computing device suitable for certain components of the computing system in FIG. 1.

### DETAILED DESCRIPTION

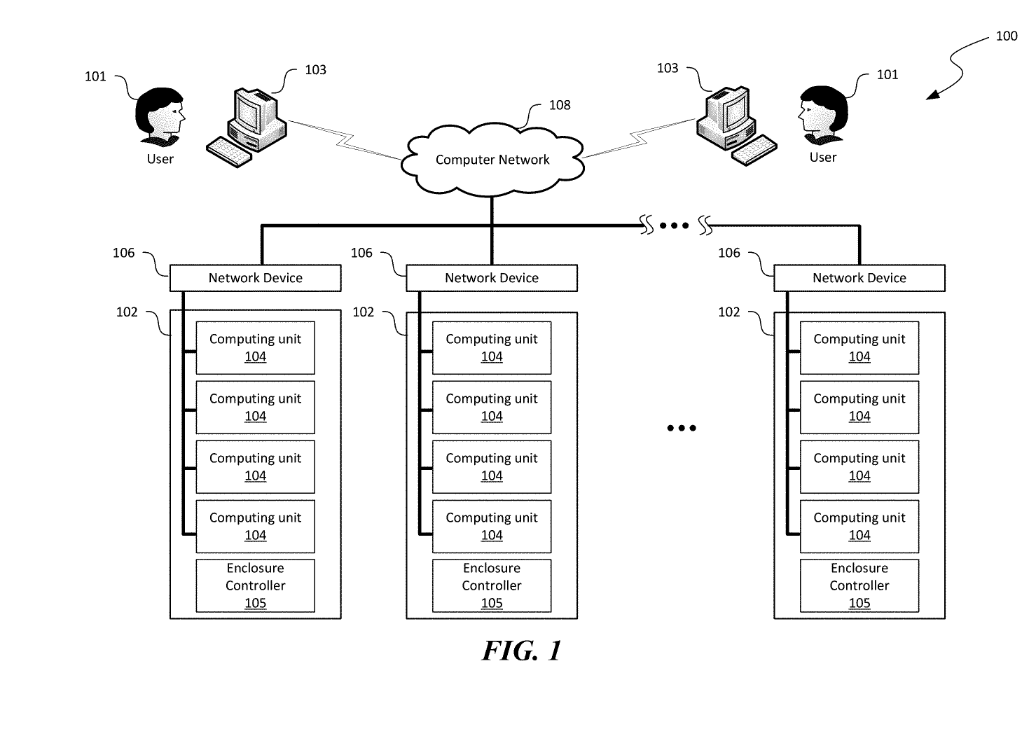

Various embodiments of computing systems, devices, components, modules, routines, and processes related to battery-based data persistence management in computing devices are described below. In the following description, example software codes, values, and other specific details are included to provide a thorough understanding of various embodiments of the present technology. A person skilled in the relevant art will also understand that the technology may have additional embodiments. The technology may also be practiced without several of the details of the embodiments described below with reference to FIGS. 1-7.

As used herein, the term “volatile memory” generally refers to a computer memory that requires power to maintain stored data. One example of a volatile memory is DRAM, which can retain stored data when powered via refreshing. When power is removed or interrupted, DRAM modules can lose stored data within minutes due to a lack of refreshing. In contrast, the term “non-volatile memory” generally refers to a computer memory that can retain stored data even without power. Examples of non-volatile memory include read-only memory (“ROM”), flash memory (e.g., NAND or NOR solid state drives or SSDs), phase change memory, spin-transfer torque magnetic random-access memory, and magnetic storage devices (e.g. hard disk drives or HDDs).

Also used herein, the term “hybrid memory device” generally refers to a computer memory device that includes one or more volatile memory modules and non-volatile memory modules operatively coupled to one another. In embodiments, a hybrid memory device can be a single hardware module (e.g., NVDIMM-Ns) having a volatile memory, a non-volatile memory, and a memory controller interconnected with one another. The hybrid memory device can have an external data bus and corresponding logic to be configured as a randomly addressable memory (“RAM”) module. Example RAM modules include DIMMs (Dual Inline Memory Modules), JEDEC (Joint Electron Device Engineering Council) DDR SDRAM, and modules configured according to other suitable RAM specifications. The one or more non-volatile memory devices can be primarily or exclusively used to facilitate or ensure that certain data in the volatile memory modules appears to be persistent. As such, data in the volatile memory modules can be persisted when power is unexpectedly interrupted or during normal shutdowns.

In embodiments, a hybrid memory device can be software implemented in a computing device having a main processor, a main memory, and a persistent storage coupled to one another via a data bus on a motherboard. The main memory can include DRAMs or other suitable volatile memory devices. The persistent storage can include SSDs, HDDS, or other suitable non-volatile memory devices. In certain implementations, certain memory blocks in the main memory can be designated as NVDIMM-SWs. During a power interruption or normal shutdown, the main processor can execute certain instructions in, for instance, BIOS of the computing device, to flush data residing in the designated blocks of the main memory to the persistent storage using power from a battery, a capacitor, or other suitable backup power sources. Upon a system reset, the persisted data in the persistent storage can be restored in the designated memory blocks of the main memory.

Also used herein, the term “main processor” generally refers to an electronic package containing various components configured to perform arithmetic, logical, control, and/or input/output operations. The electronic package can include one or more “cores” configured to execute machine instructions. The cores can individually include one or more arithmetic logic units, floating-point units, L1 and L2 cache, and/or other suitable components. The electronic package can also include one or more peripheral components referred to as “uncore” configured to facilitate operations of the cores. The uncore can include, for example, QuickPath® Interconnect controllers, L3 cache, snoop agent pipeline, memory management controllers, and/or other suitable components. In the descriptions herein, L1, L2, and L3 cache are collectively referred to as “processor cache.”

Also used herein, the term “dirty data” generally refers to data that needs to be persisted during a system shutdown, unexpected power failure, or in response to other suitable events in a computing device. In certain examples, dirty data can include user data generated and/or modified by an application (e.g., word processor, spreadsheet, etc.) executing on the computing device. In other examples, dirty data can also include event logs, system data backups, or other system generated and/or modified data that needs to be persisted. In embodiments, dirty data can correspond to certain NVDIMM (e.g., NVDIMM-SW) memory locations whose data has been modified since last being persisted to the persistent storage. In embodiments, the dirty data can be compressed according to run-length encoding or other suitable lossless data compression schemes on a per memory block (e.g., a page) basis. The dirty data can also be de-duplicated by, for example, identifying similar or the same pages of data in corresponding memory blocks, or be reduced in size according to other suitable techniques.

A NVDIMM-SW can be implemented in a computing device by designating a portion of a main memory and a persistent storage of the computing device as a volatile memory and an associated non-volatile memory. One challenge of implementing such a NVDIMM-SW is to ensure complete data flushing when the computing device is operating on a battery or other suitable backup power sources with limited power capacities. For example, a battery can be exhausted after providing power for a certain period of time. As such, the limited power capacities of the battery can limit an amount of data that can be flushed from the volatile memory of the NVDIMM-SW to the non-volatile memory of the NVDIMM-SW. Thus, if the battery runs out of power before data flushing is completed, some data residing in the volatile memory of the NVDIMM-SW can be lost. Such loss of data can negatively impact user experience and system performance of the computing device.

Several embodiments of the disclosed technology can address at least certain aspects of the foregoing challenge by tracking an amount of dirty data in the volatile memory of NVDIMM-SW to be flushed to the non-volatile memory when powered by a battery or other suitable types of backup power sources. When the tracked amount of dirty data in the volatile memory exceeds a threshold set corresponding to an available capacity of the battery, a processor or other suitable components of the computing device can trigger flushing of at least a portion of the dirty data in the volatile memory of the NVDIMM-SW to the non-volatile memory using a main power source (e.g., a power grid). As such, the remaining amount of the dirty data in the volatile memory of the NVDIMM-SW can be maintained at or below the threshold to ensure complete flushing of the remaining dirty data using only the energy capacity of the battery, and thus reducing risks of unexpected data loss due to unexpected power failures. Additional examples and embodiments of the disclosed technology are described in more detail below with reference to FIGS. 1-7.

FIG. 1 is a schematic block diagram illustrating a computing system 100 having computing units 104 configured in accordance with embodiments of the present technology. As shown in FIG. 1, the computing system 100 can include multiple computer enclosures 102 individually housing computing units 104 interconnected by a computer network 108 via network devices 106. The computer network 108 can also be configured to interconnect the individual computing units 104 with one or more client devices 103. Even though particular configurations of the computing system 100 are shown in FIG. 1, in embodiments, the computing system 100 can also include additional and/or different components than those shown in FIG. 1.

The computer enclosures 102 can include structures with suitable shapes and sizes to house the computing units 104. For example, the computer enclosures 102 can include racks, drawers, containers, cabinets, and/or other suitable assemblies. In the illustrated embodiment of FIG. 1, four computing units 104 are shown in each computer enclosure 102 for illustration purposes. In embodiments, individual computer enclosures 102 can also include ten, twenty, or any other suitable number of computing units 104. In embodiments, the individual computer enclosures 102 can also include power distribution units, fans, intercoolers, and/or other suitable electrical and/or mechanical components (not shown).

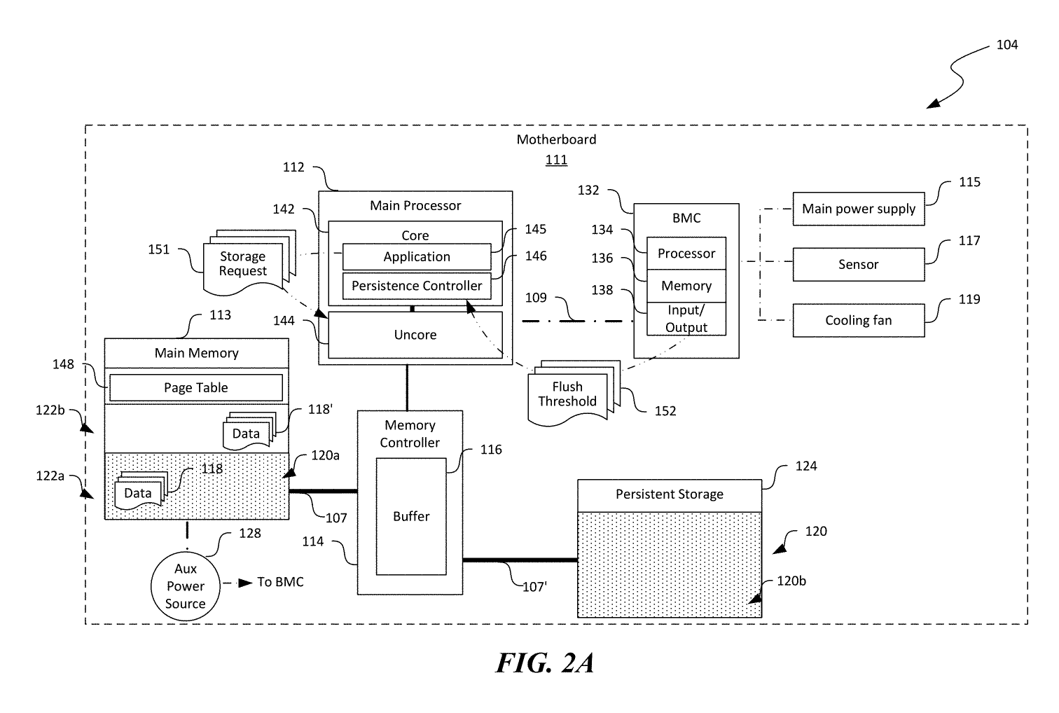

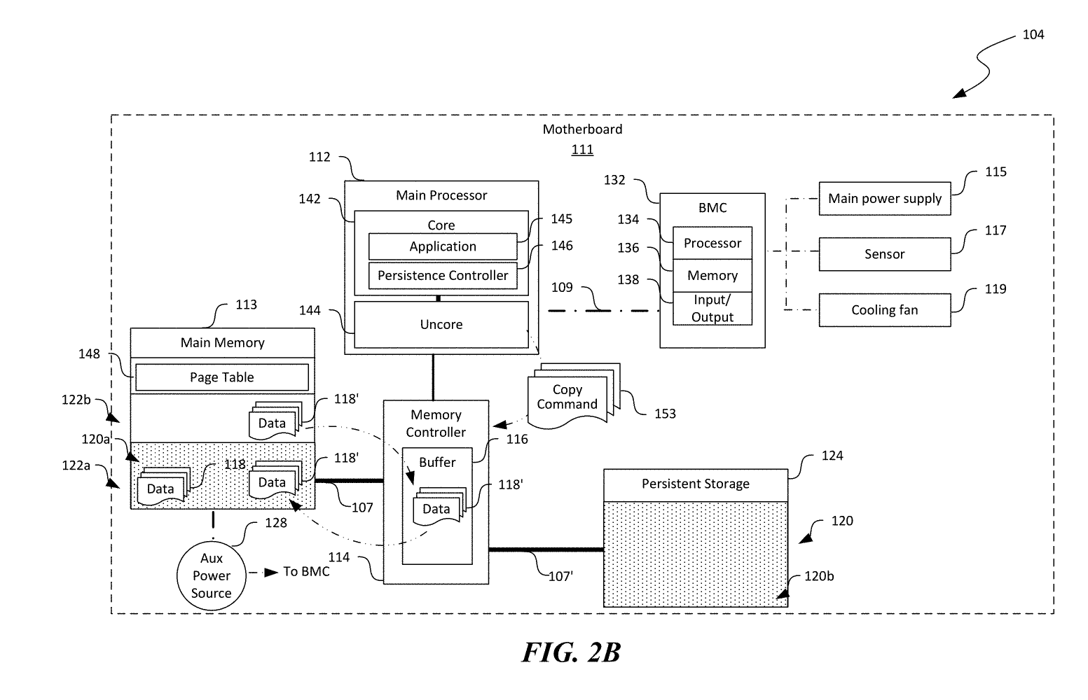

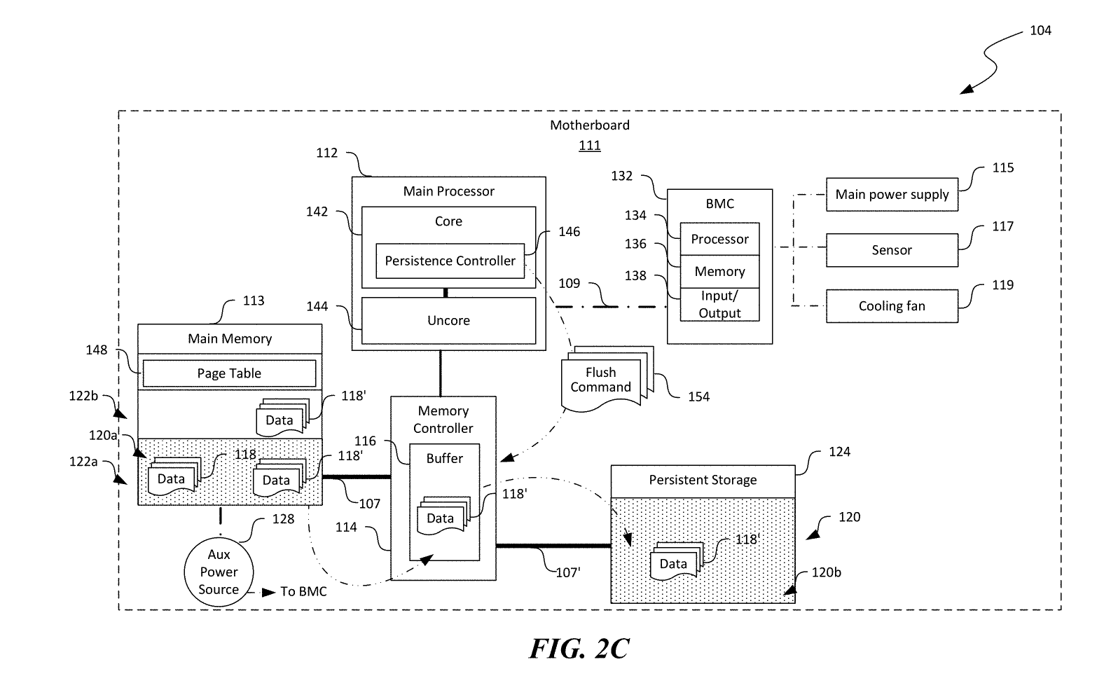

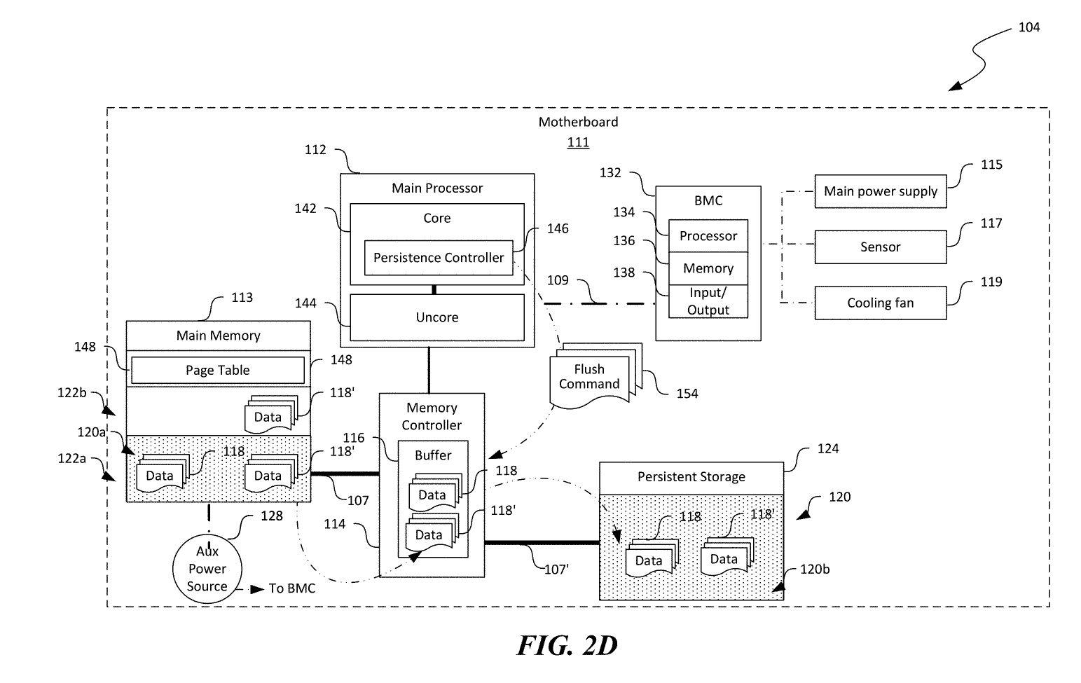

The computing units 104 can individually include one or more servers, network storage devices, network communications devices, or other suitable computing devices suitable for datacenters or other computing facilities. In embodiments, the computing units 104 can be configured to implement one or more cloud computing applications and/or services accessible by user 101 using the client device 103 (e.g., a desktop computer, a smartphone, etc.) via the computer network 108. The computing units 104 can individually include one or more software implemented hybrid memory devices 120 (shown in FIGS. 2A-2D) and can be configured to implement battery-based data persistence management in accordance with embodiments of the disclosed technology, as described in more detail below with reference to FIGS. 2A-2D.

As shown in FIG. 1, the individual computer enclosures 102 can also include an enclosure controller 105 configured to monitor and/or control a device operation of the computing units 104, power distribution units, fans, intercoolers, and/or other suitable electrical and/or mechanical components. For example, the enclosure controllers 105 can power up, power down, reset, power cycle, refresh, and/or perform other suitable device operations on a particular computing unit 104 in a computer enclosure 102. In embodiments, the individual enclosure controllers 105 can include a rack controller configured to monitor operational status of the computing units 104 housed in a rack. One suitable rack controller is the Smart Rack Controller (EMX) provided by Raritan of Somerset, N.J. In embodiments, the individual enclosure controllers 105 can include a cabinet controller, a container controller, or other suitable types of controller.

In the illustrated embodiment, the enclosure controllers 105 individually include a standalone server or other suitable types of computing device located in a corresponding computer enclosure 102. In embodiments, the enclosure controllers 105 can include a service of an operating system or application running on one or more of the computing units 104 in the individual computer enclosures 102. In embodiments, the enclosure controllers 105 in the individual computer enclosures 102 can also include remote server coupled to the computing units 104 via an external network (not shown) and/or the computer network 108.

In embodiments, the computer network 108 can include twisted pair, coaxial, untwisted pair, optic fiber, and/or other suitable hardwire communication media, routers, switches, and/or other suitable network devices. In embodiments, the computer network 108 can also include a wireless communication medium. In embodiments, the computer network 108 can include a combination of hardwire and wireless communication media. The computer network 108 can operate according to Ethernet, token ring, asynchronous transfer mode, and/or other suitable link layer protocols. In the illustrated embodiment, the computing units 104 in the individual computer enclosure 102 are coupled to the computer network 108 via the network devices 106 (e.g., a top-of-rack switch) individually associated with one of the computer enclosures 102. In embodiments, the computer network 108 may include other suitable topologies, devices, components, and/or arrangements.

In operation, the computing units 104 can receive requests from the users 101 using the client device 103 via the computer network 108. For example, the user 101 can request a web search using the client device 103. After receiving the request, one or more of the computing units 104 can perform the requested web search by, for example, executing a corresponding application, and generate relevant search results. The computing units 104 can then transmit the generated search results as network data to the client devices 103 via the computer network 108 and/or other external networks (e.g., the Internet, not shown). As described in more detail below with reference to FIGS. 2A-2D, the individual computing units 104 can include one or more software implemented hybrid memory devices 120, and can implement battery-based data persistence management in accordance with embodiments of the disclosed technology.

FIGS. 2A-2D are schematic block diagrams of a computing unit 104 suitable for the computing system 100 in FIG. 1 at various operational stages in accordance with embodiments of the disclosed technology. In particular, FIGS. 2A-2D illustrate various operational stage of the computing unit 104 during stages of tracking and managing an amount of dirty data in a volatile memory of a NVDIMM-SW based on an available capacity of an auxiliary or backup power source such as a battery. Details of the various operational stages are described below in turn.

As shown in FIG. 2A, the computing unit 104 can include a motherboard 111 carrying a main processor 112, a main memory 113, a memory controller 114, a persistent storage 124, an auxiliary power source 128, and a baseboard management controller (“BMC”) 132 operatively coupled to one another. The motherboard 111 can also carry a main power supply 115, a sensor 117 (e.g., a temperature or humidity sensor), and a cooling fan 119 (collectively referred to as “peripheral devices”) coupled to the BMC 132. The foregoing components of the computing unit 104 are described below in turn. In embodiments, the computing unit 104 can also include network interface modules, heat sinks, or other suitable components in addition to or in lieu of the foregoing components.

Though FIGS. 2A-2D only show the motherboard 111 in phantom lines, In embodiments, the motherboard 111 can include a printed circuit board with one or more sockets configured to receive the foregoing or other suitable components described herein. In embodiments, the motherboard 111 can also carry indicators (e.g., light emitting diodes), communication components (e.g., a network interface module), platform controller hubs, complex programmable logic devices, and/or other suitable mechanical and/or electric components in lieu of or in addition to the components shown in FIGS. 2A-2D.

In embodiments, the motherboard 111 can be configured as a computer assembly or subassembly having only portions of those components shown in FIGS. 2A-2D. For example, the motherboard 111 can form a computer assembly containing only the main processor 112, main memory 113, and the BMC 132 without the persistent storage 124 being received in a corresponding socket. In embodiments, the motherboard 111 can also be configured as another computer assembly with only the BMC 132. In embodiments, the motherboard 111 can be configured as other suitable types of computer assembly with suitable components. Even though the motherboard 111 is shown as having the BMC 132, in embodiments, the BMC 132 may be omitted from the motherboard 111. Instead, the components, functions, and associated operations associated with the BMC 132 described herein may be performed by a BIOS or other suitable components of the computing unit 104.

The main processor 112 can be configured to execute instructions of one or more computer programs by performing arithmetic, logical, control, and/or input/output operations related to execution of an application 145, for example, in response to a user request received from the client device 103 (FIG. 1). As shown in FIG. 2A, the main processor 112 can include a core 142, a processor cache (not shown), and an uncore 144 operatively coupled to one another. Even though only one core 142 is shown in FIG. 2A, in embodiments, the main processor 112 can include two, three, or any suitable number of cores operating in parallel, serial, or in other suitable fashions. The processor cache can include certain components of the core 142 (e.g., L1 and L2 cache) and can also include some components (e.g., L3 cache) integrated with the uncore 144. In embodiments, the processor cache can also include other suitable types of memory elements in other suitable arrangements. As shown in FIG. 2A, the main processor 112 can be operatively coupled to the BMC 132 via a board bus 109.

The main memory 113 can include a digital storage circuit directly accessible by the main processor 112 via, for example, a data bus 107. In one embodiment, the data bus 107 can include an inter-integrated circuit bus or I²C bus as detailed by NXP Semiconductors N.V. of Eindhoven, the Netherlands. In embodiments, the data bus 107 can also include a PCIE bus, system management bus, RS-232, small computer system interface bus, or other suitable types of control and/or communications bus. In embodiments, the main memory 113 can include one or more DRAM modules. In embodiments, the main memory 113 can also include magnetic core memory or other suitable types of memory. The persistent storage 124 can include one or more non-volatile memory devices operatively coupled to the memory controller 114 via another data bus 107′ (e.g., a PCIE bus). For example, the persistent storage 124 can include an SSD, HDD, or other suitable storage components.

As shown in FIG. 2A, the main memory 113 can contain a page table having entries identifying data and/or associated parameters thereof stored in certain memory blocks (e.g., pages of 4K, 16K, 64K, 128K, 256K, or other suitable sizes). For example, an entry of the page table can identify a beginning address, an ending address, a read/write status, a modified indicator, an error checking status, and/or other information associated with data (e.g., data 118) stored in the main memory 113. An example data structure for an entry of the page table 113 is described below with reference to FIG. 6.

As shown in FIG. 2A, the computing unit 104 can implement a software based NVDIMM (NVDIMM-SW) using at least a portion of the volatile main memory 113 as a volatile memory 120a and at least a portion of the persistent storage 124 as a non-volatile memory 120b. For example, In embodiments, a first portion 122a of the main memory 113 can be designated as an NVDIMM-SW 120 such that any data 118 residing in the volatile memory of the NVDIMM-SW 120 can be automatically backed up and persisted in the persistent storage 124 facilitated by the main processor 112 using power from the auxiliary power source 128. A second portion 122b of the main memory 113 can be designated, for example by default, to be a volatile memory for use as heap dynamically allocated to executing applications, reserved memory space, or other suitable uses. As such any data in the second portion 122b can be lost during a power failure or normal shutdown. In embodiments, the entire main memory 113 can be designed as an NVDIMM-SW. Even though the main memory 113 is shown as a separate component from the persistent storage 124 in FIG. 2A, in embodiments, the main memory 113 and the persistent storage 124 can be integrated into a single module, or have other suitable configurations. In embodiments, the computing unit 104 can also include another NVDIMM device (e.g., NVDIMM-N, not shown). As such, the applications executing on the computing unit 104 can be provided with a combined capacity of the NVDIMM-N and NVDIMM-SW 120.

Also shown in FIG. 2A, the main processor 112 can be coupled to a memory controller 114 having a buffer 116. The memory controller 114 can include a digital circuit that is configured to monitor and manage operations of the main memory 113 and the persistent storage 124. For example, in one embodiment, the memory controller 114 can be configured to periodically refresh the main memory 113. In another example, the memory controller 114 can also continuously, periodically, or in other suitable manners transmit or “write” data 118′ (shown in FIGS. 2B and 2C) in the buffer 116 to the main memory 113 and/or the persistent storage 124. In the illustrated embodiment, the memory controller 114 is independent from the main processor 112. In embodiments, the memory controller 114 can also include a digital circuit or chip integrated into a package containing the main processor 112, for example, as a part of the uncore 144. One example memory controller is the Intel® 5100 memory controller provided by the Intel Corporation of Santa Clara, Calif.

As shown in FIG. 2A, the main processor 112 can execute suitable instructions from, for example, the main memory 113 and/or the persistent storage 124 to provide a persistence controller 146. In embodiments, the persistence controller 146 can be configured to monitor for one or more storage request 151 (e.g., a data write request) from the application 145. In response to receiving the storage request 151, the persistence controller 146 can allocate certain memory blocks (e.g., a number of data pages) in the volatile memory 120a, and accumulate a page count of data written to the volatile memory 120a of the NVDIMM-SW 120. The persistence controller 146 may separately track the count of pages that become dirty as a result of writing the requested data and pages that are already dirty. The persistence controller 146 can increment the counter only for newly allocated pages (which become dirty upon storing the requested data) and for previously-allocated pages that are not currently dirty.

The persistence controller 146 can also be configured to compare the accumulated page count with a flush threshold 152 corresponding to an available capacity of the auxiliary power source 128. In the illustrated embodiment, the BMC 132 can be configured to monitor a current capacity of the auxiliary power source 128 and provide a flush threshold 152 (e.g., in number of pages) to the persistence controller 146. In embodiments, the flush threshold 152 can be manually set by an operator, can be decremented as a function of time, be periodically or continuously updated based on a battery state, be dynamically calculated based on a battery state and a predetermined lookup table, or can be set in other suitable manners. In response to determining that the accumulated page count is within a preselected offset from, equals to, or exceeds the flush threshold 152, the persistence controller 146 can cause at least a portion of the data 118 residing in the volatile memory 120a of the NVDIMM-SW 120 to be flushed to the non-volatile memory 120b of the NVDIMM-SW 120 using power from the main power supply 115. Upon completion of the data flush, the persistence controller 146 can then reduce the accumulated page count based on a number of pages flushed to the non-volatile memory 120b.

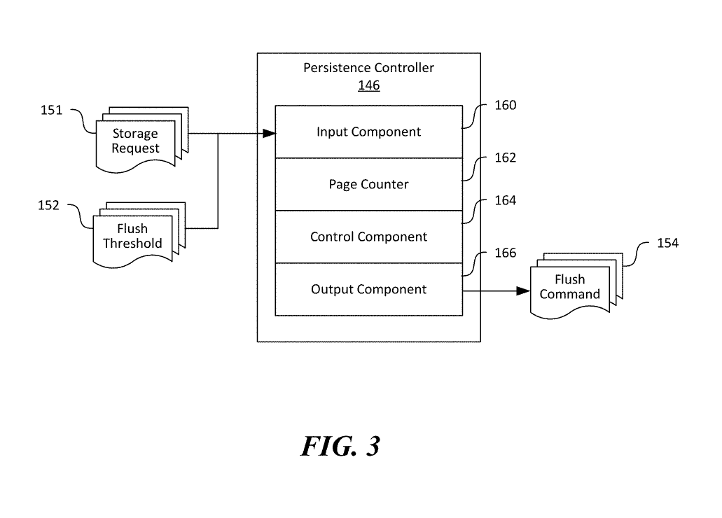

In embodiments, the persistence controller 146 can be configured to cause a predetermined number of pages of data 118 to be flushed at one time when the accumulated page count is within a preselected offset from, equals to, or exceeds the flush threshold 152 in order to ensure a predetermined number of pages of memory become available to store dirty data before reaching the flush threshold 152. Subsequent to successful flushing of the predetermined number of pages, the persistence controller 146 can be configured to repeat the comparison between the current accumulated page count with the flush threshold 152. If the accumulated page count still exceeds the flush threshold hold 152, the persistence controller 146 can be configured to cause additional predetermined numbers of pages of the data 118 to be flushed from the volatile memory 120a to the non-volatile memory 120b until the accumulated page count is less than the flush threshold 152. In embodiments, the persistence controller 146 can also be configured to determine a difference (e.g., in terms of number of pages of data) between the accumulated page count and the flush threshold 152, and cause the NVDIMM-SW 120 to flush the determined number of pages representing the difference or a factor (e.g., 2, 3, etc.) thereof from the volatile memory 120a to the non-volatile memory 120b. In embodiments, the persistence controller 146 can be configured to cause the NVDIMM-SW 120 to flush all data 118 in the volatile memory 120a to the non-volatile memory 120b when the accumulated page count is within a preselected offset from, equals to, or exceeds the flush threshold 152. In embodiments, when flushing data from the volatile memory 120a to the non-volatile memory 120b, the persistence controller 146 can ensure a predetermined number of pages of memory become available to store dirty data before reaching the flush threshold 152. Further details of functions and/or components of the persistence controller 146 are described below with reference to FIGS. 2B-2D and FIG. 3.

Even though the persistence controller 146 is shown in FIG. 2A as a software component provided by the core 142 of the main processor 112, in embodiments, the persistence controller 146 can also be implemented as a firmware and/or hardware component on the motherboard 111. In one example, the persistence controller 146 can be implemented as an Application-specific integrated circuit that is a part of the uncore 144 and/or the memory controller 114. In another example, the persistence controller 146 can be implemented as a field programmable gate array (“FPGA”) executing firmware from, for example, a basic input/output system (“BIOS”) of the computing unit 104.

The auxiliary power source 128 can be configured to controllably provide an alternative power source (e.g., +12V (volt) DC, +5V DC, −5V DC, −12V DC) to the NVDIMM-SW 120, the main processor 112, the memory controller 114, and other components of the computing unit 104 in lieu of the main power supply 115. In embodiments, the auxiliary power source 128 can provide different voltage levels (or even AC power) to different connected components (e.g., +5V to the main memory 113, +3.3V to the memory controller 114, and +12V to the persistent storage 124). In the illustrated embodiment, the auxiliary power source 128 includes a power supply that is separate from the main power supply 115. In embodiments, the auxiliary power source 128 can also be an integral part of the main power supply 115. In embodiments, the auxiliary power source 128 can include a capacitor or battery sized to contain sufficient power to write at least some of data from the portion 122 of the main memory 113 to the persistent storage 124. As shown in FIG. 2A, the BMC 132 can monitor and control operations of the auxiliary power source 128, as described in more detail below.

As shown in FIG. 2A, the BMC 132 can include a processor 134, a memory 136, and an input/output component 138 operatively coupled to one another. The processor 134 can include one or more microprocessors, field-programmable gate arrays, and/or other suitable logic devices. The memory 136 can include volatile and/or nonvolatile computer readable media (e.g., ROM, RAM, magnetic disk storage media, optical storage media, flash memory devices, EEPROM, and/or other suitable non-transitory storage media) configured to store data received from, as well as instructions for, the processor 136. In one embodiment, both the data and instructions are stored in one computer readable medium. In embodiments, the data may be stored in one medium (e.g., RAM), and the instructions may be stored in a different medium (e.g., EEPROM). The input/output component 124 can include a digital and/or analog input/output interface configured to accept input from and/or provide output to other components of the BMC 132. One example BMC is the Pilot 3 controller provided by Avago Technologies of Irvine, Calif. In embodiments, the motherboard 111 may include additional and/or different peripheral devices.

The BMC 132 can be configured to monitor operating conditions and control device operations of various components on the motherboard 111. In embodiments, the peripheral devices can provide input to as well as receive instructions from the BMC 132 via the input/output component 138. For example, the main power supply 115 can provide power status, running time, wattage, and/or other suitable information to the BMC 132. In response, the BMC 132 can provide instructions to the main power supply 115 to power up, power down, reset, power cycle, refresh, and/or other suitable power operations. In another example, the cooling fan 119 can provide fan status to the BMC 132 and accept instructions to start, stop, speed up, slow down, and/or other suitable fan operations based on, for example, a temperature reading from the sensor 117.

In embodiments, the BMC 132 can also be configured to monitor a condition (e.g., available energy capacity) of the auxiliary power source 128 and provide a corresponding flush threshold 152 to the persistence controller 146 of the main processor 112. For example, the processor 134 of the BMC 132 can be configured to execute instructions from the memory 136 to perform periodic voltage or other suitable types of energy measurements to obtain a current voltage or energy level of the auxiliary power source 128. Based on the obtained current voltage or energy level of the auxiliary power source 128, the processor 134 can be configured to correlate the measured voltage or energy level to one or more flush thresholds 152 (e.g., in terms of a number of pages) based on a predetermined function, graph, or other suitable relationship therebetween. As such, as the auxiliary power source 128 loses energy capacity over time, the BMC 132 can update the flush threshold 152 accordingly. In embodiments, the foregoing operations can be performed by an application (not shown) or a component thereof executed by the core 142, the uncore 144, a BIOS (not shown) or the memory controller 114. In embodiments, the operations of determining a flush threshold can be manually performed by an operator (not shown), who can then set the flush threshold 152 accordingly.

FIG. 2A shows an operating stage in which the main processor 112 executes an application 145 utilizing the core 142. During operation, the application 145 can transmit a storage request 151 to request writing certain data, for example, data 118′ from the second portion 122b of the main memory 113, to the NVDIMM-SW 120. The storage request 151 can include a size, type, addresses, and/or other suitable parameters of the data 118′ to be written to the NVDIMM-SW 120. In embodiments, the storage request 151 can be in response to a user action such as a save or save as command. In embodiments, the storage request 151 can be in response to a system operation such as an automatic save function of the application 145, or any other application or system logic. As shown in FIG. 2A, the volatile memory 120a of the NVDIMM-SW 120 already contains data 118.

In response to receiving the storage request 151, the persistence controller 146 can detect a number of memory blocks (e.g., pages) allocated in response to the received storage request 151. In embodiments, the main processor 112 can perform the data input/output associated with the requested write operation. In such embodiments, the persistence controller 146 can track a number of non-dirty pages actually written to the volatile memory 120a of the NVDIMM-SW 120 after applications of, for instance, data compression and/or page de-duplication. In embodiments, the request write operation can be facilitated by a direct memory access (“DMA”) controller (not shown) associated with the main memory 113 or the persistent storage 124. In such embodiments, the persistence controller 146 can identify all non-dirty data pages associated with the requested write operation as the number of pages written to the volatile memory 120a of the NVDIMM-SW 120.

Different techniques can be used for tracking the amount of data written to the NVDIMM-SW 120. In embodiments, the persistence controller 146 can track accumulated page counts based on read-and-write permissions enabled for those corresponding pages. In one example, the persistence controller 146 can initially set all available data blocks in the volatile memory 120a of the NVDIMM-SW as read-only. In response to the storage request 151 that attempts to modify a read-only page (e.g., handling a page fault for the attempt to write the read-only page), the persistence controller 146 can determine that a write was attempted to a read-only page of the NVDIMM-SW. The persistence controller 146 can then increment the accumulated page counter and then modify the memory permissions to allow writes to that page. The persistence controller 146 can also flush pages based on the flush threshold as mentioned above, and modify the permissions of the flushed pages to once again be read-only. In addition or alternatively, the persistence controller 146 may track or verify the amount of dirty data written to the NVDIMM-SW 120 by periodically scanning the volatile memory 120a for modified data or by applying other suitable techniques.

In embodiments, the memory controller 114 can be configured to track the dirty status of regions of the memory used as NVDIMM-SW. In such embodiments, a state (e.g., represented by a single bit) for each region (e.g., memory page, 1 MB, or other suitable value) of the volatile memory 122a may be tracked, including at least one state indicating dirty data and one state indicating non-dirty data. In embodiments, the tracking uses only two states, with a single bit per region of memory. The memory controller 114, when or prior to writing to a region of memory where the bit indicates the data is not yet dirty, can increment the accumulated page counter. The memory controller 114, after flushing a dirty page to the persistent storage 120b, can also decrement the accumulated page counter by, for example, the number of memory pages/blocks whose data is copied to the persistent storage 120b or other suitable numbers.

In embodiments, the main memory 113 can have hardware support for tracking regions of the main memory 113 that have been written to (i.e., dirty). The main memory 113 can have one or more bits that track the dirty status of corresponding regions of the main memory 113. As an example, the corresponding bit for a region may be set by the main memory hardware, whenever the corresponding region of main memory 113 is written to. The bits that track the dirty status may be exposed as memory addresses that can be read and written to by the memory controller 114. The memory controller 114 can, during its update/refresh cycle, read the dirty bits, write (refresh) the region, and then write (reset) the old values for those dirty bits, thus effectively allowing refreshing without modification of the dirty bits.

In embodiments implementing marking pages read-only and handling page faults to track a count of regions and/or blocks of memory that become dirty, the persistence controller 146 or other suitable components of the computing unit 104 may not be able to detect modifications of volatile memory 120a via DMA operations. In such embodiments, the persistence controller 146 or other suitable components of the computing unit 104 can designate certain pages as always dirty when these pages have been mapped for potential DMA write access. When these pages are unmapped and thus no longer writable via the DMA operations, the persistence controller 146 or other suitable components of the computing unit 104 can treat these pages as dirty until being flushed to the non-volatile memory 120b of the NVDIMM-SW 120. Such as, certain embodiments of the disclosed technology can have improved tracking of potentially dirty memory regions and/or blocks.

As shown in FIG. 2B, in response to the storage request 151 (FIG. 2A), the core 142 and/or the uncore 144 can transmit a copy command 153 to the memory controller 114. The copy command 153 instructs the memory controller 114 to copy the data 118′ from the second portion 122b of the main memory 113 to the NVDIMM-SW 120. In response to receiving the copy command 153, the memory controller 114 can read the data 118′ from the second portion 122b of the main memory 113 to the buffer 116 before creating a copy of the data 118′ in the volatile memory 120a of the NVDIMM-SW 120. The operations shown in FIGS. 2A and 2B can be repeated multiple times during which the persistence controller 146 maintains an accumulated amount of the data 118 (i.e., dirty data) in the volatile memory 120a of the NVDIMM-SW 120 that is to be persisted to the non-volatile memory 120b during, for example, an unexpected power failure of the main power supply 115.

As shown in FIG. 2C, the persistence controller 146 can periodically compare the accumulated amount of dirty data is within a preselected offset from, equals to, or exceeds the flush threshold 152 (FIG. 2A), or receive a signal (e.g., interrupt) from the memory controller 114 (e.g., an interrupt indicating the memory controller's current operation would exceed the flush threshold). In either situation, the persistence controller 146 can issue a flush command 154 to the memory controller 114 to copy or flush at least a portion of the dirty data in the volatile memory 120a to the non-volatile memory 120b of the NVDIMM-SW 120 using power from the main power supply 115. In response to receiving the flush command 154, the memory controller 114 can then read the data 118′ into the buffer 116 before creating a copy of the read data 118′ in the persistent storage 124. In the illustrated embodiment, only a portion of the dirty data (i.e., the data 118′) is to be flushed to the persistent storage 124. In embodiments as shown in FIG. 2D, all data (e.g., the data 118 and 118′) in the volatile memory 120a can be flushed to the persistent storage 124.

Several embodiments of the disclosed technology can ensure that the amount of dirty data in the volatile memory 120a of the NVDIMM-SW 120 can be completely persisted or copied to the non-volatile memory 120b of the NVDIMM-SW 120. By tracking the amount of dirty data that currently resides in the volatile memory 120a, several embodiments of the disclosed technology can periodically flush excess dirty data to the non-volatile memory 120b of the NVDIMM-SW 120 such that the amount of remaining dirty data in the volatile memory 120a can be completed persisted using power from only the auxiliary power source 128. As such, risks of data loss in the NVDIMM-SW 120 due to unexpected power failures can be reduced or even prevented to provide improved user experience.

Even though the data persistence management is described above as applying to a single computing unit 104, in embodiments, the foregoing data persistence management techniques can also be applied to a computing cluster. For example, a number of memory blocks containing dirty data can be limited in certain computing clusters (e.g., in one or more computer enclosures 102 in FIG. 1) but not in other computing clusters. In embodiments, certain computing units 104 (e.g., servers executing high importance applications) can have no or low limit on the number of memory blocks containing dirty data while other computing units 104 (e.g., servers executing low importance applications) can have limited number of memory blocks that can contain dirty data.

FIG. 3 is a block diagram showing certain computing system components suitable for the persistence controller 146 in FIGS. 2A-2D in accordance with embodiments of the disclosed technology. In FIG. 3 and in other Figures herein, individual software components, objects, classes, modules, and routines may be a computer program, procedure, or process written as source code in C, C++, C#, Java, and/or other suitable programming languages. A component may include, without limitation, one or more modules, objects, classes, routines, properties, processes, threads, executables, libraries, or other components. Components may be in source or binary form. Components may include aspects of source code before compilation (e.g., classes, properties, procedures, routines), compiled binary units (e.g., libraries, executables), or artifacts instantiated and used at runtime (e.g., objects, processes, threads).

Components within a system may take different forms within the system. As one example, a system comprising a first component, a second component and a third component can, without limitation, encompass a system that has the first component being a property in source code, the second component being a binary compiled library, and the third component being a thread created at runtime. The computer program, procedure, or process may be compiled into object, intermediate, or machine code and presented for execution by one or more processors of a personal computer, a network server, a laptop computer, a smartphone, and/or other suitable computing devices.

Equally, components may include hardware circuitry. A person of ordinary skill in the art would recognize that hardware may be considered fossilized software, and software may be considered liquefied hardware. As one example, software instructions in a component may be burned to a Programmable Logic Array circuit, or may be designed as a hardware circuit with appropriate integrated circuits. Equally, hardware may be emulated by software. Various implementations of source, intermediate, and/or object code and associated data may be stored in a computer memory that includes read-only memory, random-access memory, magnetic disk storage media, optical storage media, flash memory devices, and/or other suitable computer readable storage media excluding propagated signals.

As shown in FIG. 3, the persistence controller 146 can include an input component 160, a page counter 162, a control component 164, and an output component 166 operatively coupled to one another. The input component 160 can be configured to receive a storage request 151 from an application 145 as well as a flush threshold 152 from, for example, the BMC 132 (FIG. 2A). In response, the input component 160 can be configured to provide the received storage request 151 and the flush threshold 152 to the page counter 162 and the control component 164 for further processing.

The page counter 162 can be configured to maintain an accumulated number of pages of dirty data that needs to be persisted during an unexpected power failure, normal system shutdown, or other situations. In embodiments, the page counter 162 can be initialized to a starting value (e.g., zero) at system startup. In response to receiving a storage request 151, the page counter 162 can monitor for a number of non-dirty pages associated with the write operation and add the number of non-dirty pages written to the starting value to derive an accumulated value. The page counter 162 can also be configured to decrease the accumulated value when at least a portion of the dirty data is flushed from the volatile memory 120a (FIG. 2A) to the non-volatile memory 120b of the NVDIMM-SW 120.

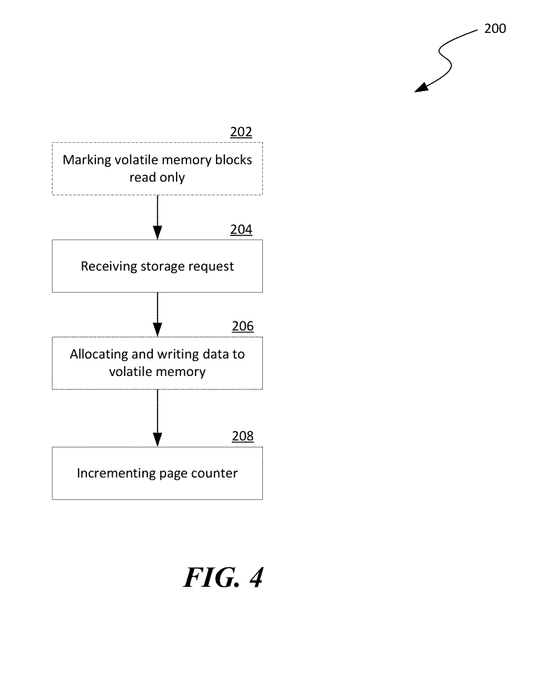

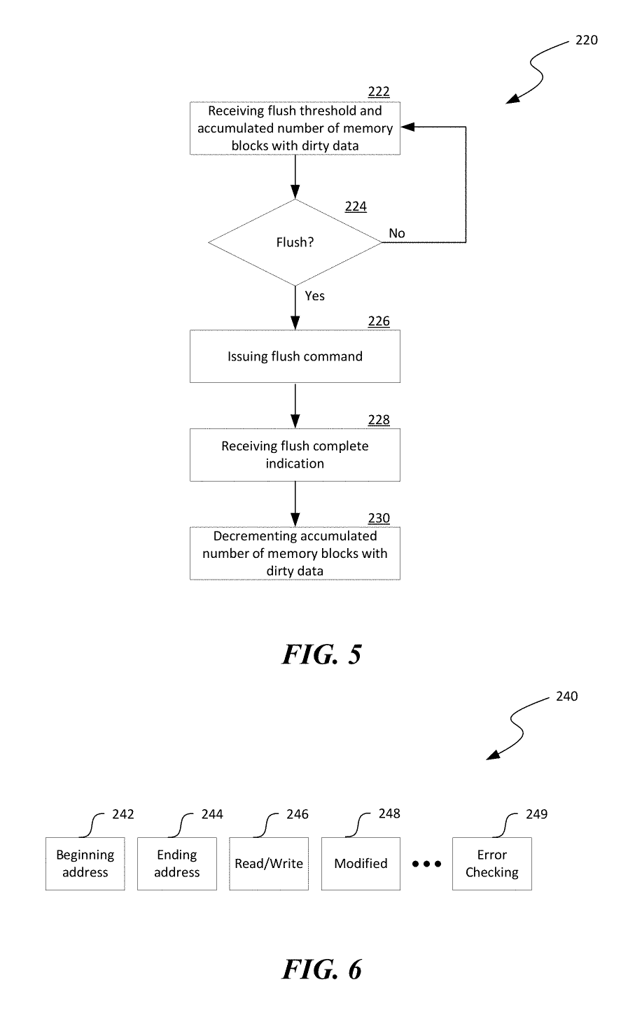

The control component 164 can be configured to compare the accumulated value generated by the page counter 162 to the flush threshold 152. In response to determining that the accumulated value is equal or exceeds the flush threshold 152, the control component 164 can instruct the output component 166 to output a flush command 154 to copy or flush at least a portion of the dirty data in the volatile memory 120a to the non-volatile memory 120b using power from the main power supply 115 (FIG. 2A). Upon completion of the data flush, the control component 164 can also instruct the page counter 162 to reduce the accumulated value according to the number of pages of data flushed in the NVDIMM-SW 120. The output component 166 can be configured to format, validate, and transmit various commands to the uncore 144, the memory controller 114, or other components of the computing unit 104. Additional functions of the various components of the various components of the persistence controller 146 are described in more detail below with reference to FIGS. 4 and 5.

FIG. 4 is a flow diagram illustrating a process 200 for implementing battery-based data persistence management in accordance with embodiments of the present technology. Even though the process 200 and other processes are described below with reference to the computing system 100 in FIG. 1 and the computing unit 104 in FIGS. 2A-2D, several embodiments of the process 200 may also be used in other computer systems or devices, such as those incorporating NVDIMM-N or other suitable types of hybrid memory devices. As shown in FIG. 4, the process 200 can optionally include marking all volatile memory blocks (e.g., pages) as read only in a volatile memory of a NVDIMM-SW at stage 202. In one embodiment, marking the volatile memory blocks can include setting a value in an entry of a page table associated with the volatile memory. In embodiments, marking the volatile memory blocks can include initializing the volatile memory blocks as all read-only. In embodiments, the operation at stage 202 can be omitted.

The process 200 can also include receiving a storage request, for example, from an application executing on a computing device, at stage 204. The storage request can include identification of data to be written to the NVDIMM-SW as well as a size, type, addresses, or other suitable parameters associated with the data. The process 200 can then optionally include allocating certain memory blocks from the main memory to be dynamically configured as the volatile memory of the NVDIMM-SW in response to the storage request. If the data would be written to non-dirty memory blocks, the process 200 can include validating that the page counter would not exceed a flush threshold as described in more detail with reference to FIG. 5. The accumulated page counter is then incremented. In embodiments where the block is read-only when non-dirty, the block may be marked as read-write prior to allowing the data to be written into the volatile memory 120a of the NVDIMM-SW at stage 206. In embodiments, writing the data can also include applying data compression, page de-duplication, or other data management techniques to the data to be written to the volatile memory of the NVDIMM-SW. In embodiments, writing the data can include writing the data in original form or other suitable forms.

FIG. 5 is a flow diagram illustrating a process 220 for implementing battery-based data persistence management in accordance with embodiments of the present technology. As shown in FIG. 5, the process 220 can include receiving a flush threshold from, for example, a user, the BMC 132 (FIG. 2A), or other suitable sources and an accumulated number of memory blocks of a volatile memory of a NVDIMM-SW that contains dirty data blocks at stage 222. The process 220 can then include a decision stage 224 to determine whether the accumulated number of memory blocks that contain dirty data is within a preselected offset from, equals to, or exceeds the flush threshold. In response to determining that the accumulated number of memory blocks is below the flush threshold, the process 220 can revert to receiving additional flush threshold and/or accumulated number of memory blocks containing dirty data at stage 222.

In response to determining that the accumulated number of memory blocks is within a preselected offset from, equals to, or exceeds the flush threshold, in embodiments, the process 220 can include issuing a flush command 226 to cause at least a portion of the dirty data in the volatile memory of the NVDIMM-SW be flushed to the non-volatile memory using power from the main power supply 115 (FIG. 2A). The process 222 can also include receiving an indication that the data flush is completed at stage 228. In response, the process 222 can include decrementing the accumulated number of memory blocks containing dirty data accordingly at stage 230. In embodiments, the process 220 can also be implemented with two or more flush thresholds. For example, when the accumulated number of memory blocks is equal or exceeds a lower flush threshold, the process 220 can include issuing a flush command 226 such that the accumulated number of memory blocks falls below the lower flush threshold. When the accumulated number of memory blocks is within a preselected offset from, equals to, or exceeds a higher flush threshold, a memory controller can be prevented from causing additional dirty pages until the accumulated number of memory blocks is reduced below the higher flush threshold.

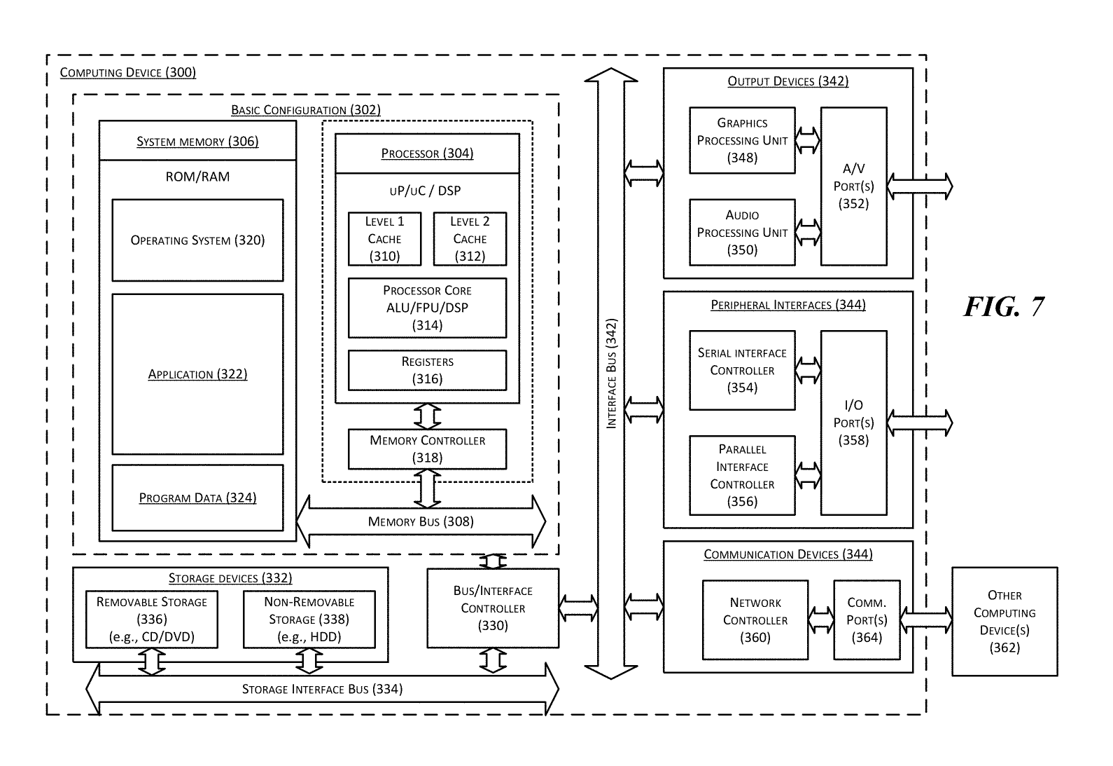

FIG. 7 is a computing device 300 suitable for certain components of the computing system 100 in FIG. 1, for example, the computing unit 104 or the client device 103. In a very basic configuration 302, the computing device 300 can include one or more processors 304 and a system memory 306. A memory bus 308 can be used for communicating between processor 304 and system memory 306. Depending on the desired configuration, the processor 304 can be of any type including but not limited to a microprocessor (μP), a microcontroller (μC), a digital signal processor (DSP), or any combination thereof. The processor 304 can include one or more levels of caching, such as a level-one cache 310 and a level-two cache 312, a processor core 314, and registers 316. An example processor core 314 can include an arithmetic logic unit (ALU), a floating point unit (FPU), a digital signal processing core (DSP Core), or any combination thereof. An example memory controller 318 can also be used with processor 304, or in some implementations memory controller 318 can be an internal part of processor 304.

Depending on the desired configuration, the system memory 306 can be of any type including but not limited to volatile memory (such as RAM), non-volatile memory (such as ROM, flash memory, etc.) or any combination thereof. The system memory 306 can include an operating system 320, one or more applications 322, and program data 324. This described basic configuration 302 is illustrated in FIG. 7 by those components within the inner dashed line.

The computing device 300 can have additional features or functionality, and additional interfaces to facilitate communications between basic configuration 302 and any other devices and interfaces. For example, a bus/interface controller 330 can be used to facilitate communications between the basic configuration 302 and one or more data storage devices 332 via a storage interface bus 334. The data storage devices 332 can be removable storage devices 336, non-removable storage devices 338, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media can include volatile and nonvolatile, removable and non-removable media implemented in any method or technology for storage of information, such as computer readable instructions, data structures, program modules, or other data. The term “computer readable storage media” or “computer readable storage device” excludes propagated signals and communication media.

The system memory 306, removable storage devices 336, and non-removable storage devices 338 are examples of computer readable storage media. Computer readable storage media include, but not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other media which can be used to store the desired information and which can be accessed by computing device 300. Any such computer readable storage media can be a part of computing device 300. The term “computer readable storage medium” excludes propagated signals and communication media.

The computing device 300 can also include an interface bus 340 for facilitating communication from various interface devices (e.g., output devices 342, peripheral interfaces 344, and communication devices 346) to the basic configuration 302 via bus/interface controller 330. Example output devices 342 include a graphics processing unit 348 and an audio processing unit 350, which can be configured to communicate to various external devices such as a display or speakers via one or more A/V ports 352. Example peripheral interfaces 344 include a serial interface controller 354 or a parallel interface controller 356, which can be configured to communicate with external devices such as input devices (e.g., keyboard, mouse, pen, voice input device, touch input device, etc.) or other peripheral devices (e.g., printer, scanner, etc.) via one or more I/O ports 358. An example communication device 346 includes a network controller 360, which can be arranged to facilitate communications with one or more other computing devices 362 over a network communication link via one or more communication ports 364.

The network communication link can be one example of a communication media. Communication media can typically be embodied by computer readable instructions, data structures, program modules, or other data in a modulated data signal, such as a carrier wave or other transport mechanism, and can include any information delivery media. A “modulated data signal” can be a signal that has one or more of its characteristics set or changed in such a manner as to encode information in the signal. By way of example, and not limitation, communication media can include wired media such as a wired network or direct-wired connection, and wireless media such as acoustic, radio frequency (RF), microwave, infrared (IR) and other wireless media. The term computer readable media as used herein can include both storage media and communication media.

The computing device 300 can be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. The computing device 300 can also be implemented as a personal computer including both laptop computer and non-laptop computer configurations.

From the foregoing, it will be appreciated that specific embodiments of the disclosure have been described herein for purposes of illustration, but that various modifications may be made without deviating from the disclosure. In addition, many of the elements of one embodiment may be combined with other embodiments in addition to or in lieu of the elements of the other embodiments. Accordingly, the technology is not limited except as by the appended claims.

I/We claim:

1. A method performed in a computing device having a processor, a main memory, a persistent storage, a main power supply, and an auxiliary power source operatively coupled to one another, the method comprising:
receiving a storage request to persistently store data in the computing device;
in response to receiving the storage request,
allocating a number of memory blocks of the main memory to store the data associated with the storage request;
allowing the data to be stored in the allocated number of memory blocks of the main memory;
incrementing an accumulated number of memory blocks in the main memory that contain data stored in response to the received storage request and one or more other storage requests; and
maintaining the accumulated number of memory blocks in the main memory below a threshold corresponding to an energy capacity of the auxiliary power source; and
copying all of the stored data in the memory blocks of the main memory to the persistent storage using power from only the auxiliary power source when the main power supply suffers an unexpected power failure.

2. The method of claim 1, further comprising:
comparing the accumulated number of memory blocks to the threshold corresponding to the energy capacity of the auxiliary power source; and
in response to determining that the accumulated number of memory blocks is within or equal to a preselected offset from the threshold, causing at least a portion of the stored data in the memory blocks of the main memory be copied to the persistent storage using power from the main power supply.

3. The method of claim 1, further comprising:
measuring an energy capacity of the auxiliary power source of the auxiliary power source;
correlating the measured energy capacity of the auxiliary power source to a number of memory blocks of the main memory that can be persisted to the persistent storage using power from only the auxiliary power source; and
setting the number of memory blocks as the threshold.

4. The method of claim 1, further comprising:
comparing the accumulated number of memory blocks to the threshold corresponding to the energy capacity of the auxiliary power source; and
in response to determining that the accumulated number of memory blocks is within or equal to a preselected offset from the threshold,
causing at least a portion of the stored data in a predetermined number of the memory blocks of the main memory be copied to the persistent storage using power from the main power supply; and
decrementing the accumulated number of memory blocks by the number of the memory blocks whose data is copied to the persistent storage.

5. The method of claim 4, further comprising repeating the comparing, causing, and decrementing operations until the accumulated number of memory blocks is not within the within or equal to the preselected offset from the threshold.

6. The method of claim 1, further comprising:
comparing the accumulated number of memory blocks to the threshold corresponding to the energy capacity of the auxiliary power source; and
in response to determining that the accumulated number of memory blocks is within or equal to the preselected offset from the threshold,
determining a number of memory blocks representing a difference between the accumulated number of memory blocks and the threshold; and
causing the stored data in the determined number of memory blocks of the main memory be copied to the persistent storage using power from the main power supply.

7. A computing device, comprising:
a processor, a main memory, a persistent storage, a main power supply, and an auxiliary power source operatively coupled to one another, the main memory containing instructions executable by the processor to cause the processor to:
receive storage requests to persistently store data in the computing device when the main power supply is available;
in response to receiving the individual storage requests,
allocate a number of memory blocks of the main memory to store the data associated with the storage request, the main memory being a volatile memory;
increment an accumulated number of memory blocks in the main memory that contain data stored in response to the received storage requests; and
maintain the accumulated number of memory blocks in the main memory below a threshold corresponding to an energy capacity of the auxiliary power source sufficient to copy a corresponding amount of data from the main memory to the persistent storage; and
in response to an unexpected power failure of the main power supply, copying the data stored in the memory blocks of the main memory to the persistent storage using power from the auxiliary power source, thereby ensuring all of the data stored in the memory blocks of the main memory is persisted in the persistent storage.

8. The computing device of claim 7 wherein the main memory also containing instructions executable by the processor to cause the processor to:
compare the accumulated number of memory blocks to the threshold corresponding to the energy capacity of the auxiliary power source; and
in response to determining that the accumulated number of memory blocks is within or equal to the preselected offset from the threshold, cause at least a portion of the stored data in the memory blocks of the main memory be copied to the persistent storage using power from the main power supply.

9. The computing device of claim 7 wherein the main memory also containing instructions executable by the processor to cause the processor to:
measure an energy capacity of the auxiliary power source of the auxiliary power source;
correlate the measured energy capacity of the auxiliary power source to a number of memory blocks of the main memory that can be persisted to the persistent storage using power from only the auxiliary power source; and
set the number of memory blocks as the threshold.

10. The computing device of claim 7 wherein the main memory also containing instructions executable by the processor to cause the processor to:
compare the accumulated number of memory blocks to the threshold corresponding to the energy capacity of the auxiliary power source; and
in response to determining that the accumulated number of memory blocks is within or equal to a preselected offset from the threshold,
cause at least a portion of the stored data in a predetermined number of the memory blocks of the main memory be copied to the persistent storage using power from the main power supply; and
decrement the accumulated number of memory blocks by the number of the memory blocks whose data is copied to the persistent storage.

11. The computing device of claim 10 wherein the main memory also containing instructions executable by the processor to cause the processor to repeat the comparing, causing, and decrementing operations until the accumulated number of memory blocks is not within the within or equal to the preselected offset from the threshold.

12. The computing device of claim 7 wherein the main memory also containing instructions executable by the processor to cause the processor to:
compare the accumulated number of memory blocks to the threshold corresponding to the energy capacity of the auxiliary power source; and
in response to determining that the accumulated number of memory blocks is within or equal to a preselected offset from the threshold,
cause all of the stored data in the allocated memory blocks of the main memory be copied to the persistent storage using power from the main power supply; and
decrement the accumulated number of memory blocks by the number of the memory blocks whose data is copied to the persistent storage.

13. The computing device of claim 7 wherein the main memory also containing instructions executable by the processor to cause the processor to:
compare the accumulated number of memory blocks to the threshold corresponding to the energy capacity of the auxiliary power source; and
in response to determining that the accumulated number of memory blocks is within a preselected offset from equal to the threshold,
determine a number of memory blocks representing a difference between the accumulated number of memory blocks and the threshold; and
cause the stored data in the determined number of memory blocks of the main memory be copied to the persistent storage using power from the main power supply.

14. A computing device, comprising:
a processor, a main memory, a persistent storage, a main power supply, and an auxiliary power source operatively coupled to one another, the main memory containing a number of volatile memory blocks storing data to be persistently stored in the computing device; and
wherein the main memory also containing instructions executable by the processor to cause the processor to:
track an accumulated number of volatile memory blocks in the main memory that contain the data to be persistently stored in the computing device; and
compare the accumulated number of volatile memory blocks to a threshold corresponding to an energy capacity of the auxiliary power source corresponding to copying data from the main memory to the persistent storage; and
in response to determining that the accumulated number of volatile memory blocks is within or equal to a preselected offset from the threshold, cause at least a portion of the stored data in the volatile memory blocks of the main memory to be copied to the persistent storage using power from the main power supply.

15. The computing device of claim 14 wherein the main memory also containing instructions executable by the processor to cause the processor to:
detect a power failure of the main power supply; and
in response to the detected power failure of the main power supply, copying the data stored in the volatile memory blocks of the main memory to the persistent storage using power from the auxiliary power source.

16. The computing device of claim 14 wherein the main memory also containing instructions executable by the processor to cause the processor to:
periodically measure an energy capacity of the auxiliary power source of the auxiliary power source;
correlate the measured energy capacity of the auxiliary power source to a number of volatile memory blocks of the main memory that can be persisted to the persistent storage using power from only the auxiliary power source; and
set the number of volatile memory blocks as the threshold.

17. The computing device of claim 14 wherein the main memory also containing instructions executable by the processor to cause the processor to subsequent to at least a portion of the stored data in the volatile memory blocks of the main memory is copied to the persistent storage using power from the main power supply, decrement the accumulated number of volatile memory blocks by the number of the volatile memory blocks whose data is copied to the persistent storage.

18. The computing device of claim 17 wherein the main memory also containing instructions executable by the processor to cause the processor to repeat the comparing and causing operations until the accumulated number of volatile memory blocks is not within the within or equal to the preselected offset from the threshold.

19. The computing device of claim 14 wherein the main memory also containing instructions executable by the processor to cause the processor to:
in response to determining that the accumulated number of volatile memory blocks is within or equal to a preselected offset from the threshold,
cause all of the stored data in the allocated volatile memory blocks of the main memory be copied to the persistent storage using power from the main power supply; and
decrement the accumulated number of volatile memory blocks by the number of the volatile memory blocks whose data is copied to the persistent storage.

20. The computing device of claim 14 wherein the main memory also containing instructions executable by the processor to cause the processor to:
in response to determining that the accumulated number of volatile memory blocks is within a preselected offset from equal to the threshold,
determine a number of volatile memory blocks representing a difference between the accumulated number of volatile memory blocks and the threshold; and
cause the stored data in the determined number of volatile memory blocks of the main memory be copied to the persistent storage using power from the main power supply.
